(19) United States
(12) Patent Application Publication
(10) Pub. No.: US 2019/0146515 A1
(43) Pub. Date: May 16, 2019

(54) METHOD AND DEVICE FOR DRIVING A SELF-MOVING VEHICLE AND RELATED DRIVING SYSTEM

(71) Applicant: INFO SOLUTION S.P.A., Vimodrone (MI) (IT)

(72) Inventors: Giovanni DE SALVO, Roma (RM) (IT); Francesco PALMERI, Monte Porzio Cafone (RM) (IT); Attilio PRIOLO, Passo Oscuro-Fiumicino (RM) (IT)

(21) Appl. No.: 16/304,457

(22) PCT Filed: Nov. 10, 2017
(86) PCT No.: PCT/IB2017/057036

§ 371 Date: Nov. 26, 2018

(30) Foreign Application Priority Data
Nov. 11, 2016 (IT) 102016000114161

(51) Int. Cl. G05D 1/02; G05D 1/00; B60W 30/095; B60W 30/09; G08G 1/16

(52) U.S. Cl. CPC G05D 1/0223; G05D 1/024; G05D 1/0088; G05D 2201/0213; B60W 30/09; G08G 1/166; B60W 30/0953

(57) ABSTRACT

A method of driving a vehicle equipped with an obstacle sensor is disclosed, which includes the execution in parallel of operations for calculating an optimal driving trajectory in order to impart to the vehicle a pair of values of angular speed and of tangential speed. A device for driving a vehicle and a driving system of a vehicle having a 3D sensor are also disclosed.

### TECHNICAL FIELD

This disclosure relates to the driving methods of vehicles and more particularly to a driving method of a self-moving vehicle able to avoid obstacles, a related device that implements such a method as well as a driving system comprising at least a 2D or 3D sensor functionally connected to such a device.

### BACKGROUND OF THE INVENTION

The term Obstacle Avoidance (OA) indicates the ability of an autonomous driving system to avoid collisions with obstacles within the environment in which the system is moving. This functionality can be decomposed into 3 basic steps according to the classification introduced in the work of Rosen et al.¹: 1 C. Rosen and N. Nilsson, “Application of intelligent automata to reconnaissance,” tech. rep., DTIC Document, 1968.
1. Sense.
2. Plan.
3. Act.

The vehicle during its navigation needs to sense (1) the surrounding environment to know the features of interest in it (e.g. the presence of obstacles or of aids for navigation). This knowledge is obtained thanks to the sensors installed on-board. In practice, sensing is the functionality of the system to acquire the information necessary for its motion by means of on-board sensors. The acquired data are analyzed in step 2, that is, the plan. This functionality consists in extracting information contained in the sensors to define a model of the perceived data (“modeling”). The model is used to establish the eventual presence and the position of the obstacle that the vehicle must avoid in order to avoid compromising the outcome of the mission assigned to it. The system in this step translates the acquisition of step 1 into a format that can optimize the decision functions on the data (e.g. a grid representation).

During motion, the vehicle analyzes gathered data by applying functions to be optimized to obtain the best possible decision in terms of commands to be sent to the motors. The commands obtained in step 2 are then translated into a format suitable for the actuators and sent to them at the last step, ie, 3. There are several implementations of Obstacle Avoidance for self-moving vehicles. For example, in the Urban Challenge held by the Defense Advanced Research Projects Administration (DARPA) in October 2005, five self-moving vehicles ended a race in which vehicles had to travel more than one hundred miles in total autonomy, avoiding possible collisions with obstacles in the environment. The state-of-the-art approaches that tackle and solve the problem of obstacle avoidance are numerous. ²³⁴. The Obstacle Avoidance algorithm “Dynamic Window Approach” (DWA) was published in 1997 by Dieter Fox et al. An advantage of this algorithm, which makes it appreciated and commonly used, is its limited the computational weight thanks to the fact that it is possible to reduce the space of the considered trajectories to those actually compatible with the physical accelerations of the moving device. As a matter of fact, this aspect also highlights a limitation of these algorithms, i.e. that it is not possible to evaluate a large number of trajectories because of the generated computational weight, and this may cause a limitation for the vehicle's possibilities, particularly in the case of vehicles with strong acceleration and deceleration capabilities. Furthermore, limiting the number of trajectories sets limitations on the granularity and therefore on the accuracy of trajectories. This limitation is more evident with the introduction of even more accurate sensors; in particular, the technological leap that led from the use of sonar sensors, as in the case of the development of the DWA algorithm, to the use of the extremely precise LIDAR technology, has created the need to identify a technique to manage this large amount of data. Finally, the DWA must be executed very quickly so that the predictions it generates (described later on) can be considered reliable, thus it is not possible to increase the number of processed trajectories by increasing the processing time. 2 B. P. Gerkey and K. Konolige, “Planning and control in unstructured terrain,” in In Workshop on Path Planning on Costmaps, Proceedings of the IEEE International Conference on Robotics and Automation (ICRA, 2008.)3 D. Fox, W. Burgard, and S. Thrun, “The dynamic window approach to collision avoidance,” IEEE Robotics Automation Magazine, vol. 4, pp. 23-33, March 1997.4 I. Ulrich and J. Borenstein, “Vfh+: Reliable obstacle avoidance for fast mobile robots,” in Robotics and Automation, 1998. Proceedings. 1998 IEEE International Conference on, vol. 2, pp. 1572-1577, IEEE, 1998.

The commands generated in the DWA algorithm consist of two real scalar quantities: the tangential speed v desired by the algorithm and the angular speed w of rotation around the center of instantaneous rotation coinciding, for example, with the geometric center of the moving device in case of differential kinematics. This choice allows to decrease the size of the search space of the algorithm to a two-dimensional space R² by making the performance of the DWA suitable for its use in real time. The search space is limited by a window called “Dynamic Window” which excludes, from the aforementioned space, inadmissible trajectories (v, ω) by the robot as they cannot be assumed by the vehicle within the time slot that separates two successive executions of DWA according to the maximum acceleration/deceleration of the vehicle. In addition, from the search space are excluded all those trajectories that would make the vehicle collide with an obstacle, taking into account the maximum deceleration that can be imparted to the moving device. Among the remaining trajectories in the search space, the DWA selects the best trajectory based on an objective function that maximizes indexes, such as:

1. The progress of the trajectory towards the direction desired by the user.
2. The vehicle speed (to be maximized to move as quickly as possible in the work space).
3. The distance of the closest obstacle to the system, to avoid to go in proximity to obstacles.

The main limitation of the above described algorithm is the intermediate representation of the data coming from the sensors (information used to calculate possible collisions). The chosen approach is a linear approximation in the Cartesian representation of the acquired data that does not guarantee a complete and reliable description of the actual contour of the obstacle. This could lead to incorrect decisions on the safety of certain trajectories.

The document US 2007/0219720 discloses a navigation and control system that includes a sensor configured to locate objects in a predetermined field of view from a vehicle. The sensor has an emitter configured to repeatedly scan a two-dimensional sector of a plane defined with respect to a first predetermined axis of the vehicle and a detector configured to detect a reflection of the emitted beam.

The U.S. Pat. No. 8,825,260 discloses methods for detecting objects and the ground on which a vehicle is moving. A vehicle-based computing device is configured to determine if a detected point is an obstacle or is part of the ground on which the vehicle is moving.

The document DE102013214631 discloses a method for sensing whether the space surrounding a vehicle equipped with detection sensors is occupied or not.

The document EP2149799 discloses a method for detecting the road and any obstacles for a self-moving vehicle equipped with a scanning laser sensor.

The document EP2722687 discloses a safety device for a vehicle, in particular a self-moving vehicle, which has at least one optoelectronic sensor for the detection of the surrounding space.

### SUMMARY OF THE INVENTION

Studies carried out by the applicant have led to the identification of an algorithm to calculate very quickly the trajectories that a self-moving vehicle can follow without impacting obstacles, overcoming at least partially the limitations of the known methods. This algorithm is used in a method for driving a vehicle according to this disclosure, as defined in the enclosed claim 1.

Particular embodiments are defined in the dependent claims.

Also disclosed are a device configured to implement the method for driving according to this disclosure, as well as a driving system comprising at least one 3D or 2D sensor functionally connected to such a device.

The claims as filed are an integral part of this disclosure and are herein incorporated by reference.

### BRIEF DESCRIPTION OF THE DRAWINGS

FIG. 1 illustrates the representation in polar coordinates on the travel plan of a detected obstacle point in respect to a sensor.

FIG. 2 illustrates a circular arc path designed to bring a sensor S into an arrival point P.

FIG. 3 schematically illustrates a trilobite expansion technique of the shape of a vehicle.

FIG. 4 is a functional diagram of a device that implements the method of this disclosure.

### DETAILED DESCRIPTION

### Sensor Description (Sensing)

Before introducing the method of this disclosure, it is useful to recall the operation of the 3D and 2D ranging sensors. A 3D/2D ranging sensor is an electronic or electromechanical device able to sense a “cloud of points” measured in the surrounding environment. A point cloud is defined as a set of points (or measures) acquired in the sensor's field of view. A single point belonging to the cloud is described, in polar coordinates, by 3 scalars:
Distance measure (range),
Horizontal angle of measure,
Vertical angle of measure (present only in the case of 3D ranging sensors).

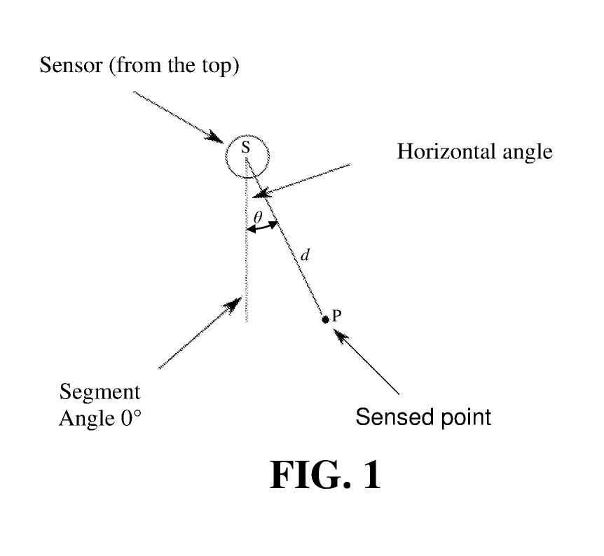

A representation of the horizontal angle is shown in FIG. 1; the sensor is represented by the circle at the top.

Usually, the 3D ranging sensors are formed, inside them, by pairs emitter-receiver, i.e. elements capable of emitting a signal and receiving the corresponding reflected signal. The time elapsed by the instant of emission of the signal to the gathering of the reflected signal, and/or the phase variation of the signal, are used for calculating the distance measure. The receiver-emitter pairs are positioned on a platform able to rotate on itself, or alternatively they are arranged in line (“array”) and activated electronically to scan the environment. At each time instant, the sensor sends a data burst to the processing unit containing the readings of the pairs activated during the scan performed during the elapsed period. By accumulating all measures obtained along the visual field of the sensor, a “cloud” of points is created which constitutes a metric representation of the environment surrounding the sensor. A complete and direct acquisition of the surrounding space takes place for example through the use of 3D ranging sensors.

A partial acquisition, but still sufficient in some operational scenarios, is given by the acquisition of a single plan generated by a planar (2D) sensor positioned horizontally. A 2D sensor may also be positioned on an inclined plane facing the bottom. This inclined 2D sensor returns a detection profile that varies over time depending on the vehicle motion. By knowing the motion of the vehicle in proximity of successive scans of the sensor, a 3D reconstruction of the space is obtained.

In the present method it is also possible to use multi-camera acquisition apparatuses together with a processing for the extraction of information about depth, or can be used systems on a single or multiple 3D camera, or systems on a single or multiple radar, or systems on multiple 3D ranging sensors, or a combination of these.

The sensors used in the method of this disclosure for detecting obstacles provide coordinates of the positions of obstacle points detected by the sensors by scanning the space around the vehicle. At each scanning of the space in front of the vehicle, a set of points in the three-dimensional space is scanned, which must then be processed to decide whether they constitute insurmountable obstacles for the self-moving vehicle or not. Generally, it is preferred to obtain spherical or polar coordinates of the detected points from the sensors, and for this reason we will refer to this type of representation in the ensuing description. However, what will be said may be repeated mutatis mutandis even if it is preferred to get from the sensors the positions of the detected points in cylindrical or Cartesian coordinates.

### Modeling

According to the method of this disclosure, it is examined the processing of the acquired data and the method for discriminating configurations of points to be associated with an obstacle, i.e. an element against which any impact must be avoided, and a set of collection of data that may be considered an area that can be crossed by the vehicle, such as the road itself or small bumps, which do not constitute a presence to be taken into consideration in order to avoid obstacles.

An element that cannot be overcome is shown on a polar two-dimensional plane coinciding with the road plan of the vehicle itself, by projecting the front of the obstacle closest to the vehicle. Hereinafter, this detection will be referred to simply as an “obstacle”. The obstacle may be fixed or moving with respect to the ground or to the vehicle.

If the input data are already acquired in spherical coordinates (three-dimensional case) or polar (two-dimensional case), the data are ready for being processed, otherwise, they are to be converted into one of these two representations.

The processing of data represented in spherical coordinates may be organized into:
analysis in a vertical plane, scanned for various angles between the horizontal reference plane and the aiming direction along which the distance is measured.
analysis in a horizontal plane, scanned for various angles between a vertical reference plane and the aiming direction along which the distance is measured.

In case of a planar representation, a single plane will be scanned for various aiming direction angles along which the distance is measured.

The analysis of the vertical plane may lead to the identification of 2 categories of obstacle profiles: ramp profile and discontinuous profile. The ramp profile includes obstacles such as: i) “ramp”; ii) “stepwise”; iii) “pole”, and anything else that has a positive or a negative height in respect to the ground.

### Ramp Profile

If the measured distances reveal an increasing trend, as the vertical detection angle decreases (this angle will be maximum when pointing downwards, zero when it is horizontal, negative when turned above the horizontal), they belong to a ramp profile: from the obtained information about the distance from the ground and the height of each point it is possible to estimate the slope between the detected points. In the presence of a slope that cannot be overcome by the vehicle, the total height of the points contained in a distance interval equal to the vehicle's wheelbase is calculated. Adding up all the heights and comparing this result (which is the overall obstacle height) with a maximum threshold that can be overcome, it is established whether the ramp can be overcome or is an obstacle.

The geometrically measured slope can be compensated with vehicle attitude data, coming from an external device that is useful only in conditions of critical off-road routes.

The definition of the obstacle, as an element that rises steeply beyond the allowed slope and height thresholds, is made dynamical according to the detected material. If the material is uniform (wall, stone, sheet, etc.) a more stringent threshold will be selected, if discontinuous (grass) a wider threshold is selected.

In this way, in “off-road” conditions, a zone of grass higher than a solid obstacle of the same height can be crossed, which is instead to be avoided.

The recognition of dense grass is carried out with an operation carried out over the scanning of the horizontal plane, of all the planes facing downwards and of all the points of the plane. By performing the processing on the horizontal sequence, the difference is calculated with the previous detection on the same horizontal plane, with the respective sign, which represents the sign of the derivative. The sign is stored and compared with the sign of the next variation. Each change of sign, with differences in distance typical of grass surveys (distance between the blades of grass from a centimeter to tens of centimeters) is considered a positive event for the recognition of grass and, multiplied by a gain factor, is added in a specific accumulator for the current circular sector (i.e. the portion of circle enclosed between two radii and an arc). The absence of change of sign and the very limited difference indicates instead a smooth surface and is added with a negative sign. For each circular sector the value obtained on several scans is accumulated and a threshold comparison is carried out to discriminate the grass. The operation provides information about the presence of grass on the specific circular sector.

Preferably, the summing and comparing operations between integers are performed in place of the first and second derivative calculation, in order to speed up processing.

### Discontinuous Profile

Sets of isolated points, not distributed at increasing distance on the same vertical plane as in a ramp, constitute a discontinuous profile.

The discontinuous profile is presented when measurements on a vertical plane reveal a slope between adjacent points of more than 90°, or slopes with a direction opposite to the direction of travel of the vehicle.

In such cases two other types of obstacle are identified. The first is the mesh, characterized by points generally not adjacent to the vertical or horizontal plane. The projection of these points on the two-dimensional plan of motion gives rise to a set of isolated or contiguous points; if the number of isolated points is higher than a defined threshold, we are in the presence of a “mesh” obstacle which as such is identified and located on the two-dimensional travel plane. The second type is the bridge obstacle. This type of obstacle is characterized by points concentrated in a continuous area between vertical planes, and located at a height smaller than or equal to that of the self-moving vehicle and greater than the maximum obstacle height exceeded by the self-moving vehicle.

The obtained two-dimensional binary map, is a plant representation of obstacles, namely the points that cannot be traversed by the vehicle, detected in the previous modeling step. Such a binary map will then contain the angular position θ and the distance d of the projections on the travel plane of points that cannot be crossed located in the three-dimensional space.

This map undergoes to a filtering that evaluates the “width” of the obstacles on the horizontal plane. If a set of contiguous points, i.e. the “width” of that obstacle is smaller than a defined threshold, the element represents a blade of grass or an insect and is not identified as an obstacle.

Since the mesh has already been recognized in the analysis phase of the vertical plane, such a filtering is disabled in the presence of a mesh, since it, although not having a detectable thickness, must however be reported as an obstacle and therefore must not be masked by this filter.

In addition to the obstacles described so far, a specific method is dedicated to “pit” type obstacles.

The profile of the hole is covered by the ground, so the method applied to the ramp obstacles might not see a distance into the hole and then calculate all the characteristics as described above. For this reason only data from observations downwards are used, so as to respect the geometrical and kinematic constraints of: height of the detection origin point (the sensor height from the ground), distance of the detection projected to the ground (the base of the detection), speed and useful stopping space for the vehicle.

Geometric and visibility constraints can prevent the correct discrimination between a hole (obstacle), and a descent (not an obstacle), until it is close enough. For this reason we prefer to use the ambiguous measurements, carried out remotely, only to reduce the speed. Those of an identified hole, but now close, define an obstacle to be avoided.

Once identified an optimal plane for the measurement of the depth (i.e. a plane with sufficient downward inclination, but with a point of incidence on the ground not too close to the stop space of the vehicle), it determines a quota that is memorized as a plan of reference and will take into account the depth detected in the previous scan. In the absence of previous data or in case of invalid data, the reference plane coincides with the ideal flat plane (absence of holes or ramps). By comparing the previous measurements with the current measurement, it is possible to better discriminate a hole from a downhill ramp. In fact, a hole will be characterized by a sudden drop in altitude, so the difference with the reference plane will suddenly exceed the depth threshold of the maximum hole that can be overcome, while a ramp will be characterized by a gradual difference in height. It is possible to make the maximum angle, that defines a descending ramp that cannot be overcome, coincide with the angle subtended between the depth of the maximum surmountable hole and the distance between the current detection and the previous detection in order to simultaneously identify holes and ramps that are too steep, as obstacles, thus to be detected, discriminating them from superable ramps which, on the contrary, do not represent obstacles.

When the vehicle attitude is inclined upward in front of the travel plane, (high pitch), the information given by the pitch sensor is used to eliminate false detection of holes, caused instead by an inclination upwards of the sensor.

In the absence of detected obstacles, the polar diagram will show a distance equal to the maximum value of visibility obtainable with that sensor in those conditions.

Therefore, the absence of obstacles is never contemplated. By contrast, there will be real obstacles that are far enough or fictitious obstacles derived from the maximum visibility and/or sensitivity of the sensor. Even the latter may be generally ignored because as they are far enough. Otherwise, a significant reduction in the distance of the fictitious obstacle, evenly distributed over the whole diagram, would result in a reduction of the vehicle speed, as desired and as will be explained hereinafter when describing the step for generating trajectories.

At the conclusion of the construction of the planar diagram of obstacles, the possibility of acquiring data from several sensors at the same time is also considered. These sensors may differ because of their position or because of their type (lidar, radar, sonar, etc.). The platform will manage synchronization with the data of the obstacles coming from multiple sources and will guarantee the congruence of the provided data. The synthesis of this information, synchronized and congruent with each other, simply takes place in most of the selection detection near equal angle θ.

### Obstacle Extension

According to a preferred embodiment, this first two-dimensional binary map is transformed in the following way.

It is possible to imagine to project the physical encumbrance of the vehicle on the obstacle map and then to consider the vehicle as a point. For example, if 2 points, represented as not traversable in the first two-dimensional binary map, were separated from each other by a distance smaller than the width of the vehicle, the vehicle could not pass between these two points, so this situation could be treated as if these two uncrossable points were joined by other fictitious points, generating a representation of a solid obstacle extended between them.

Similarly, even the solid obstacle is preferably extended with a series of fictitious points for a measure related to the size of the vehicle and in respect to the safety respect margins to be held with respect to the obstacle during an avoidance maneuvering, in order to avoid lateral or latero-frontal collisions while traveling.

### Vehicle Expansion

The technique of vehicle expansion, implemented directly on polar coordinates and called in the following “three-lobes expansion” is illustrated schematically in FIG. 3. In order to generalize both the position of the sensor S, which may not be unique and may not be placed at the center of the vehicle, as well as to better approximate the shape of the safety margins to the shape of the vehicle, it acts as if the vehicle had the curved margins shown in FIG. 3. Substantially, a certain number of circular sectors is identified (in FIG. 3, five circular sectors are identified) centered in the sensor on the vehicle, each circular sector being identified by a central angle and a radius. In this way, calculations are greatly simplified because the distance, from the nearest point of the vehicle edge, of a point of obstacle localized by the polar coordinates θ, d with origin in the sensor S will be given by the difference between the distance d with respect to the sensor S and the radius of the circular sector in which the angle θ falls. If were defined 3 distance values and 2 angles that determine the passage between two points, as shown in FIG. 3, there would be a figure made up of three lobes. In general it is also possible to use a single lobe, which is equivalent to approximating the vehicle with a sphere, or it is possible to increase the number of lobes at will to increase the accuracy with which the perimeter determined by the lobes circumscribes the vehicle.

The generation of the trajectories, that will be described below, dynamically processes the stopping distances with respect to the vehicle speed without taking into account, in a dynamical fashion, the lateral margins between the vehicle and the obstacle. Commonly, however, it is preferred to avoid to make the vehicle pass sideways to an obstacle at a distance of a few centimeters while maintaining the same speed with which it would move in wider free spaces, although the impact is not expected in both cases, avoiding the risk of collision due to possible lateral oscillations, while controlling the vehicle, whose amplitude is proportional to the speed of the vehicle itself. At the same time, it is preferred not to exclude always narrow spaces, since at relatively low speeds (hereinafter called “maneuvering speeds”) the crossing of passages with margins of distance slightly greater than those of the vehicle itself may be required. For this reason, according to an embodiment, the margins of the three-lobes expansion of the vehicle profile are adapted according to the speed and to the free space around the vehicle. A maneuvering speed, below which it is permitted to make the vehicle travel even with reduced margins from obstacles, a cruising speed above which the possible trajectories are only those that allow greater margins, and a condition of “door obstacle”, where the lateral occupation is reduced to the minimum possible, are defined. During a configuration phase, a safety margin is defined for the various conditions listed above and then the system adapts these distances in a dynamic way.

In case of free space and high speed, the safety margins will be the maximum distances; in case of a door obstacle and reduced speed, the safety margins will be the minimum ones.

It should be noted that this dynamic expansion of obstacles occurs with small variations and gradually over time, to avoid oscillations. Moreover, the definition of these dynamic margins has nothing to do with the avoidance of obstacles, which will be described later and which takes into account the braking distance.

In particular, when the condition of “door obstacle” occurs, the vehicle can assume a trajectory that passes through the free space only if the vehicle speed is lower than the maneuvering speed. This ensures that the narrow-margin mode is implemented not only on the basis of speed, but also on the basis of the type of obstacle, causing the vehicle to never get too close to the obstacles when it is not necessary, and not to reduce the speed when it is not necessary.

The recognition of the door obstacle is instead useful to avoid approaching to narrow areas without exit (dead end behind the door obstacle) or narrow corners (maneuvering space, downstream of the door obstacle, insufficient for executing any maneuver).

The implementation technique of the obstacle extension is optimized for a digital calculation system and is performed according to a function with input and output in polar coordinates. This function receives as an entry the position of the obstacles on the plane and returns as a result the position of “extended” obstacles, corresponding to real obstacles approaching to the vehicle and that are widened according to the position of the sensor, with respect to the parameters of both side and front safety distances that are to be kept between the obstacles and the vehicle itself. The parameter that defines the lateral margin between the vehicle and the obstacle is differentiated for the right side and for the left side, so as to compensate any asymmetrical positioning of the sensor with respect to the longitudinal axis of the vehicle. Since all processing takes place in polar coordinates, the enlargement of each single point takes place in an amount which is inversely proportional to the distance of the point itself. Each detected point is extended in a circular manner and, from the overlapping of the circles thus obtained, the nearest edge is selected. Since the description in polar coordinates of a generic circle, i.e. with a non-origin center, is very complex, implementation is preferably obtained with a linear approximation and with the use of a look-up table. The reconstruction of the profile of the obstacles is thus linearly approximated. However, this approximate reconstruction tracks the circular shapes in a sufficiently accurate manner for the construction of the profile defining the extended impact surface, although it is calculated in a way that is not particularly onerous.

According to an embodiment, the memory of the obstacles in the plane is scanned twice in order to carry out the extension first to the right and then to the left with respect to the point of origin. A FIFO memory is used for storing the distance information about the previously processed obstacles and compares it with the current obstacle in order to memorize that at the shortest distance. The FIFO memory stores: the considered angle, the distance of the point and the number of sectors on which it should be extended, i.e. the coverage ratio, that is inversely proportional to the distance (obtainable from polar geometry and from the extent of the enlargement which represents the lateral occupancy of the vehicle). A state machine reads the contents of the FIFO memory and the current angle to be extended, compares the two distances of the obstacles from the sensor and select as an output the shortest distance; then it reiterates this operation until the data in the FIFO memory has a smaller angular distance than that relative to its coverage ratio, and finally, it rewrites in the FIFO memory its current angle data.

The so obtained two-dimensional binary map is substantially a binary representation of points in the travel plane through which the vehicle, that may be approximated as a point, cannot pass. At each scan of the front space made by the three-dimensional/two-dimensional sensors, the two-dimensional binary map is updated. As a result, the device that controls the vehicle will have information, in the form of polar coordinates (angle θ, distance d), about the insurmountable obstacles through which the trajectory of the vehicle shall not pass.

### Trajectory Generation

According to the DWA algorithm, each trajectory of a vehicle may be approximated with a succession of straight line segments and circular arcs (of various radii of curvature) tangent to the trajectory at the point in which the vehicle is located. To define the rectilinear or curvilinear segment to follow, it is necessary to indicate the tangential speed and the angular speed to be maintained within a time interval of predetermined duration, preferably corresponding to the acquisition time of the sensor/sensors. Each of the rectilinear or circular trajectories to be followed is thus fully identified by a pair of values (angular speed ω, linear speed v).

A difficulty encountered with the known processes for the calculation of the trajectory of self-moving vehicles, consists in that the operations to be performed for avoiding detected obstacles in real time have a very high computational weight, thus the vehicle must necessarily move at a relatively low speed in order to have enough time to recalculate the trajectory when an obstacle is detected, or the vehicle must be equipped with a powerful computing unit and consume a lot of energy, to allow the execution of calculations in a short time.

In the method according to the present disclosure, the operations required for the calculation of trajectories that are expected to impact the vehicle against an obstacle, are organized according to a parallel algorithm that allows to reduce the execution time.

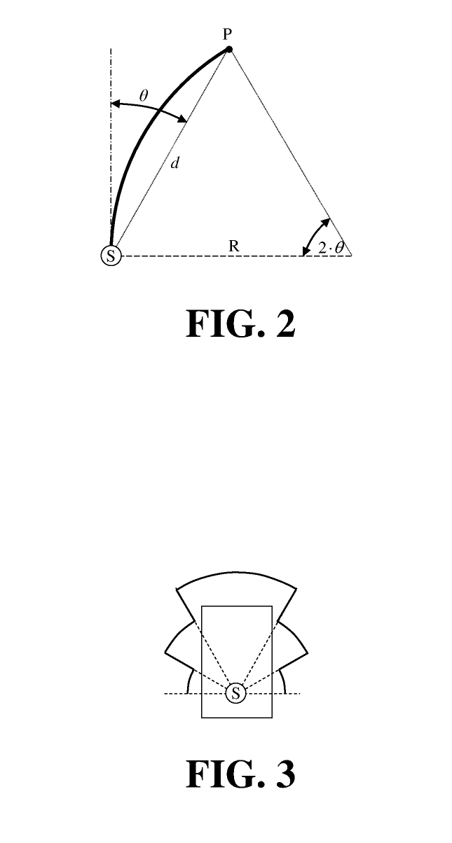

In order to better understand the method of this disclosure, reference is made to FIG. 2 which shows schematically the point S, which is an approximate representation of the vehicle at the starting point on the travel plane, a point of arrival P in which there is an insurmountable obstacle, a circular-arc trajectory that leads from the starting point to the point of arrival and the relative radius of curvature R.

The condition of impact along a curvilinear trajectory from the starting point to the obstacle identified by the polar coordinate angle=θ and distance=d, can be expressed with the following equation:

2R sin θ=d;

in which:

R is the radius of curvature of the followed curvilinear trajectory, that may be also represented as a function of tangential and angular speed of the vehicle, with the following equation

v=R·ω

in which:

v is the tangential speed of the vehicle,

ω the angular speed of the vehicle.

According to the method of this disclosure, the products mult1 and mult2 are calculated:

mult1=2v sin θ;

mult2=d·ω;

in function of which the impact condition is reformulated in the following equation;

mult1=mult2.

Once determined that the trajectory identified by the pair of values of angular speed ω and tangential speed v could lead to an impact, it derives the distance scheduled for the impact and thus the length of the trajectory free from impacts. This length corresponds to the length of the arc of circumference of the trajectory, from the vehicle up to the point of impact, and can be calculated for example as the product of the radius of curvature R and the central angle 2θ.

The trajectories for which the condition of collision is not verified will be the trajectories to which preferably a maximum length will be associated, which conveniently does not exceed the realistic limits of the sensor, so as to maintain the same order of magnitude between all lengths, both in the presence and in the absence of impact.

The mathematical representation of the impact condition is obviously expressed for a continuous space. Considering that the two-dimensional map of the obstacles is a discrete set characterized by a quantization error equal to the angular resolution, and that also the space of the trajectories is identified by pairs of values v and w of a quantized scale, it is necessary to manage the transition from a condition of impact in a continuous surface to that in a quantized surface.

For this reason, it is preferred to define a neighborhood of validity of the equality of the two products mult1 and mult2, the amplitude of which is correlated to an error of quantization applied in the generation of the map. A constant angular distance, in polar coordinates, does not guarantee a constant linear distance between points that define an obstacle and this makes variable the definition of the margin of quantization for the occurrence of the impact condition.

In order to overcome this drawback, besides the condition of impact against the front surface of the obstacles, that can be solved with a fixed quantization margin derived directly from the quantization of the angle and from the accuracy of the calculation, it is advisable to add the condition of non-crossing of the areas covered by an obstacle, that is a limit due to the impossibility of knowing the presence of obstacles behind the profile of an obstacle. This is done in order not to consider an area free from obstacles what in reality is an area in which obstacles are not visible because covered by other obstacles.

To make the problem more clearly, it should be kept in mind that the processed trajectories are semicircular and that in case of two adjacent obstacle-points detected in polar coordinates, one very close and one far away, it is possible to draw a curve away from both points that passes behind the nearest obstacle, without causing impacts because the detection of the presence of obstacles is hindered by the presence of the nearest obstacle. Conveniently, trajectories free from obstacles, because of coverage, should not be considered equivalent to those definitely free from obstacles and then prevent that the generated optimal trajectory could in certain cases create curves that end in non visible areas. This precaution is dictated by prudential reasons, indeed also a human driver would not enter in a space hidden from his view, unless he has a reasonable certainty that such a space is sufficiently free from obstacles. The just described behavior may be modulated according to the conditions of risk of the operational scenario (e.g. an open space to explore, or a path to follow with a blind curve).

The discrimination between the trajectory that passes in front of the obstacles (the case without risk) from the path that passes behind an obstacle (case with presence of risk) is obtained by applying the inequality among the factors calculated above: when mult2 is less than mult1,

mult2<mult1

the trajectory identified by the pair of values of angular speed ω and tangential speed v may cross an area covered by an obstacle, so it may happen that the vehicle impacts against an obstacle hidden from its view. According to one embodiment, such a trajectory may be discarded or may be evaluated taking into account priorities related to the operating conditions.

The method of this disclosure may be executed quickly because the numerous products mult1 and mult2 may be calculated all independently, whilst minimizing all division operations. The factors involved in the calculation of the products mult1 and mult2 or of the used amounts θ, v, ω, d, are known because they are defined in the previously described steps. At this point the calculation of the impact condition and the distance free from impacts, may be executed with a high level of parallelism. The use of electronic devices able to carry out parallel computations, such as FPGAs, it is particularly appropriate and allows to execute the algorithm in extremely short times. A further reduction in processing time is achieved by the fact that the calculation is limited to the operations of addition, comparison and multiplication.

This gives the possibility to explore a considerable number of trajectories (in the order of several thousand) in a negligible time, compared to the time of acquisition needed by the sensors. The obtained advantages lead to the possibility of processing data from different sensors simultaneously, of exploring trajectories otherwise neglected for computational reasons, of meeting extremely short response times, of limiting the overall consumption of the device.

The algorithm execution continuation is relatively simpler both from a computational point of view as well as a conceptual point of view. Once the pairs of values of angular speed ω and tangential speed v that the vehicle can take are identified, it is necessary to choose a pair and to move the vehicle with that angular speed ω and with that tangential speed v.

In general, any pair of values can be chosen in the set of pairs that define all safe trajectories, that is trajectories having a distance from impacts greater than the distance required to stop the vehicle, or that do not lead to other dangerous situations such as rollover or slipping. Preferably, the choice of the pair of values, within the set of safe trajectories, may be made according to several criteria including the following: reaching the arrival in the shortest time, choosing a pair of values that makes the vehicle move more quickly and that does not turn the vehicle away from the arrival point; or avoiding braking or sudden accelerations, thus choosing a pair of values that does not alter too quickly the state of motion of the vehicle; or avoiding bumps to the passengers on board the vehicle, thus choosing a pair of values that impart the smallest possible angular speed.

For example, in the aforementioned article about the Obstacle Avoidance Algorithm “DynamicWindow Approach” (DWA) published in 1997 by Dieter Fox et al., criteria, usable in the method of this disclosure, are disclosed for the assignment of performance scores to admissible trajectories in order to choose one among the many trajectories that may be safely followed by the vehicle.

The presented approach performs a selection process of the “best” trajectory on the basis of a score to be maximized. The function for calculating the score will conveniently consider at least the following three factors:

1. The distance free from obstacles along the semicircular trajectory, by assigning a higher score to greater distances free from obstacles,
2. The linear speed, by assigning a higher score for higher linear speeds,
3. The “heading” error, i.e. the deviation from the ideal trajectory directed toward the arrival, assigning a higher score for smaller “heading” errors.

Each of these factors is multiplied by a respective gain coefficient, corresponding to the importance that the factor must have for the final choice.

The lengths of all the trajectories from the vehicle position to the collision point, if present, have been calculated as described above.

In the phase of optimization of the score function, the error of the trajectory is instead calculated in respect to the desired trajectory; such an error is expressed by the angle of detection of the arrival and the central axis of the vehicle, estimated at the end of the hypothetical trajectory. The error is then transformed into a figure of merit, which is maximum in correspondence of the minimum error (trajectory aimed to the arrival).

Before carrying out the weighted sum of contributions, stopping distances are calculated in function of the speed space, so that all the speeds that would imply a distance from the obstacle greater than the space necessary to stop, are considered inadmissible because they are unsafe. In the same way, all desired kinematic limits are set, such as the conditions for preventing slippage or rollover, for example by placing a limit to the centrifugal acceleration to which the vehicle may undergo, that is given by the product between the linear speed v and the angular speed ω. Once the maximum value of the score function is obtained, the pair of angular and linear speed, that generated the highest score and that was not discarded as dangerous, is selected.

The self-moving vehicle is driven so that the latter moves with the angular speed ω and the tangential speed v corresponding to the trajectory to which the highest score is associated among the calculated scores.

In the method of this disclosure it is possible to take into account obstacles on the map, virtual obstacles, or detections coming from other sensors, conveniently through a specific acquisition interface.

When there is an unexpected and too close obstacle, the trajectory calculation returns an information of inevitable impact, at least by implementing the actions permitted by the current configuration parameters. It is thus requested the extreme action of braking, of activating safety procedures, or choosing the impact that will cause the smallest damage. The modeling by type of obstacles may thus be instantly modified to perform the sequence of removal of obstacles with predetermined priorities and the calculation of alternative trajectories. This type of operation is carried out in a very short time, thus it does not affect the decision on the overall latency of the system that will implement the described method.

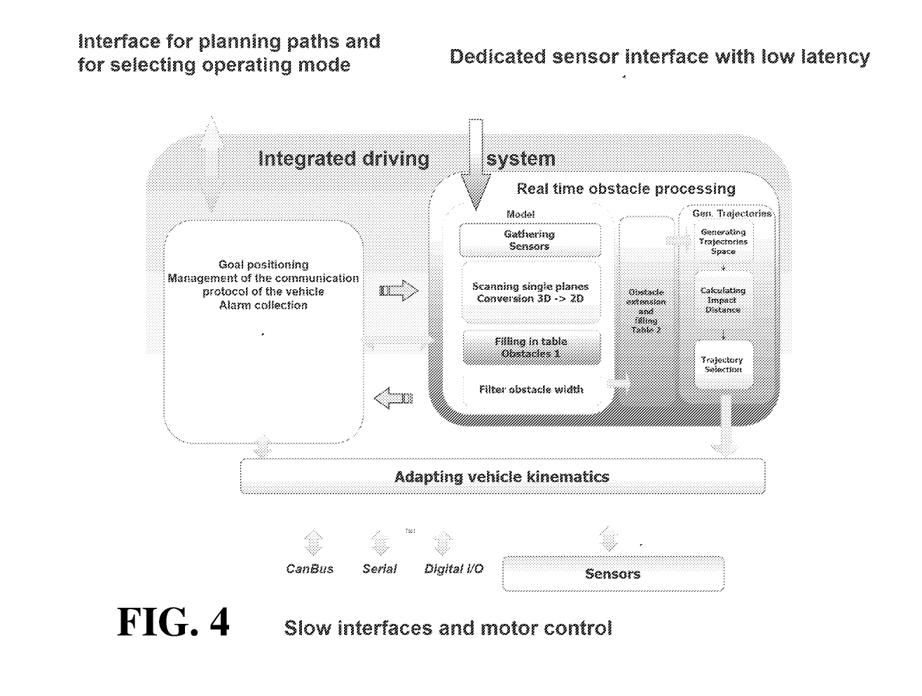

FIG. 4 shows a functional diagram of an example of a device that implements the method of this disclosure. It conveniently contains a dedicated section to define a point of arrival (“goal”), and to communicate with the vehicle to be driven and to manage any alarm signal. This section will communicate with a unit of real-time processing that performs the described process, that acquires the detections of the sensors, generates the first table and possibly the second table of obstacle points in the travel plan of the vehicle, then analyzes the space of trajectories and chooses a trajectory (i.e. a pair of values of angular speed w and of tangential speed v) taking into account the free distance that may be followed before impacting with an obstacle point. Optionally, the device is configured to take into considerations kinematic characteristics of the vehicle, for example by limiting the values of angular speed w and of tangential speed v in order not to exceed a maximum centrifugal force tolerable by the vehicle.

The described modeling and generation function of the trajectories may be for example entirely realized with a FPGA or SoC (System on Chip). The described architecture is modular and is completely autonomous in its specific function. In addition, the implementation takes full advantage of the multipliers available in the technology, for example of the DSP multipliers.

The communication for the control of the parameters occurs through a map of registers and, for maximum integration reasons, the whole programmable hardware part may reside on a SoC platform equipped with a processor. The embedded SW can handle all the functions relating to the location, to the generation of the virtual obstacles and to the possible communication and conversion of the values w and v in suitable controls for driving the vehicle, thanks to a kinematic model of the same. The physical ports towards the sensors can be dedicated HW (hardware ports) connected directly to the FPGA. The FPGA device can also directly generate the PWM signals for controlling the driver of the motor and of the servomotors and for reading the status of the encoder for calculating the speed. It is thus possible to realize completely in HW all the functions for avoiding obstacles, which is the sensitive part for the purposes of safety and for guaranteeing a maximum time of overall algorithm execution in the order of 1 millisecond, independently of the functionality implemented in the SW (software).

Features of “Product” Modeling of Obstacles:
10/100 Ethernet port dedicated to the acquisition of the LIDAR data on FPGA;
Processing in streaming on FPGA and latency equal to 70 us;
geometric analysis of the kind of obstacle;
internal resolution equal to 0.18° on the horizontal plane (1024 points per floor on 180°) with donwsampling and pre-filtering of the raw data, capable of ensuring the minimum loss of information;
reconstruction of missing profiles as a result of failed ranging acquisitions;
Fault detection of the sensor and of the connection;
state of alarm and limitation of speed up to the stop in order to ensure safety in real time as a function of the state of operation of the sensor;
automatic synchronization with the sensor and reduction of the overall latency (acquisition latency of a front obstacle equal to 25 ms, with LIDAR rotation frequency equal to 100 ms);
possibility of multiple and simultaneous acquisition from multiple sensors and from a synthetic input for virtual obstacles on the floor;
Discrimination of the kind of obstacle: ramps, holes, steps, metal mesh;
filtering for the elimination of noise or fake obstacles, such as a single blade of grass or an insect;
Detailed parameterization of the obstacle geometry and consequent definition of the type of path that will be followed automatically (from the off-road to the smooth track);
recognition of special conditions such as the presence of dense grass or narrow passages with automatic adaptation to the operating conditions;
possibility of managing any blind zones of the sensor.

Features of “Product” of the Generation of the Trajectories and Selection of the Trajectory:
Input obstacles defined by polar diagram (radar);
separate control and possibility of limiting: linear acceleration, centrifugal acceleration, deceleration, angular acceleration, angular speed and tangential speed. These limitations are going to determine the admissible trajectories and can be modified during the execution of the algorithm to facilitate tuning, or to modify the behavior of the vehicle in a dynamic way;
safety margin from obstacles defined on the basis of the calculation of the stopping distance depending on the current speed and on the maximum deceleration contemplated for the vehicle, with a configurable friction on the ground during the execution;
quantization of the trajectories and maximum time of configurable processing;
minimum execution time 500 us with exploration of 512 trajectories;
Automatic synchronization of control with the timing of acquisition of the obstacles;
Interlock feature for changing parameters via SW;
control via variable amplitude step implemented at high-frequency and with feedback on the measured current speed, to ensure robustness, reliability and absence of vibrations;
high-level hysteresis to prevent oscillations of the trajectory;
implemented by a digital communication protocol and predisposition for electrical PWM outputs controlled by FPGA.

Features of “Product” of the Localization and Communication System:
Gigabit Ethernet Interface dedicated to communication between embedded CPU and any external CPU;
communication middleware over TCP-IP protocol with 2 priority levels;
4 Serial Ports for motor controllers, sensors, GPS, etc.;
2 CanBus for motor and servo motors control;
GPS positioning;
transformation of the goal (arrival) position from absolute coordinates to robot coordinates;
transformation of constraints defined in absolute coordinates into constraints in robot coordinates: “Virtual walls”;
Alarm collection, fault detection.

Table of performance achieved in terms of time:

| Calculation | Time |
|---|---|
| modeling | 70 us |
| obstacles Extension | <400 us |
| Calculation of 2048 | 640 us (160 us 512 trajectories) |
| trajectories and selection of the | |
| trajectory | |
| Total time obstacle avoidance | 0.63 ms-1.1 ms |
| | (Based on the number of selected |
| | trajectories) |
| Human Reaction Time | 200 ms |

From the comparative table it is evident that the method of this disclosure is able to identify a trajectory, that a self-moving vehicle must follow, in a time about two hundred times shorter than the human reaction time. Therefore, it can be validly used as a driving aid and/or for driving at cruising speeds typical vehicles in real situations.

1. A method for driving a vehicle equipped with an obstacle detection sensor, comprising:
periodically scanning a space in front of the vehicle by means of said sensor;
at each scanning period of said sensor, carrying out the following operations:
a) filling in a first two-dimensional table with pairs of polar coordinates, in respect to the sensor, of angle θ and of distance din a running plane of the vehicle, of insurmountable obstacle points sensed by the sensor, and
b) for each angle θ and for each distance d of insurmountable obstacle points, calculating admissible trajectories for preventing a collision with a detected obstacle,
calculating said admissible trajectories for each angle θ and for each distance d of unsurmountable obstacle points by carrying out the following operations:
b1) for each pair of values of angular speed ω and of tangential speed v that the vehicle may assume, carrying out the following operations:
b1a) calculating a first product mult1 and a second product mult2 such that
mult1=2v sin θ;
mult2=d·ω;
b1b) if for the pair of values of angular speed ω and of considered tangential speed v the condition mult1<mult2 is substantially verified, storing said pair of values in a table of admissible trajectories; and
b1c) if for the pair of values of considered angular speed ω and of tangential speed v the condition mult1=mult2 is substantially verified, calculating a length of a trajectory free from impacts and, if the length of the free trajectory is greater than a braking distance of a vehicle, storing said pair of values in the table of admissible trajectories; and
c) moving the driven vehicle, during said scanning period, with angular speed ω and tangential speed v of a pair of values stored in the table of admissible trajectories.

2. The method of claim 1, comprising carrying out the following operations after the step b1):
b2) assigning a respective performance score to each pair of values of angular speed ω and of tangential speed v stored in the table of admissible trajectories; and
c) moving the driven vehicle, during said scanning period, with angular speed ω and tangential speed v of a pair of values stored in the table of admissible trajectories to which a maximum performance score is associated.

3. The method according to claim 2, comprising the execution of the following operation after the step b1a and before the step b2:
b1d) if for the considered pair of values of angular speed w and of tangential speed v the condition mult1>mult2 is substantially verified, either discarding said pair of values or storing it in a table of unsafe trajectories.

4. The method according to claim 1, comprising the step of estimating the length of the trajectory free from impacts with the distance d, eventually multiplied by a correction factor dependent upon the angle θ.

5. The method according to claim 1, wherein said sensors are 3D/2D type sensors and are configured to generate at each scanning period a set of pairs of planar coordinates or triples of cylindrical or spherical or Cartesian coordinates of obstacle points detected by the sensors, said coordinates being processed to define said first two-dimensional table of pairs of polar coordinates of obstacles through at least one of the following operations:
processing the distribution of obstacle points sensed by the sensors for detecting obstacles with smoot or rough profile,
selecting a maximum height threshold of insurmountable obstacles for the vehicle in function of the rough or smooth profile of the detected obstacle,
calculating a slope and/or a height of the detected obstacle and comparing said slope and/or said height with respective thresholds, thus deciding in function of said comparison whether the detected obstacle is surmountable or insurmountable for the vehicle; and
filling in said first table with pairs of polar coordinated of angle θ and of distance d of projections on the running plane of the vehicle of points of detected obstacle recognized as insurmountable.

6. The method of claim 1, comprising, after step a) and before step b), the operation of filling in a second two-dimensional table of pairs of polar coordinates of angle θ and of distance d of insurmountable obstacle points, through the following operations:
a1) importing from the first two-dimensional table all the pairs of polar coordinates of angle and of distance of insurmountable obstacle points,
a2) for each pair of insurmountable obstacle points in said first two-dimensional table spaced by a distance smaller than a width of the vehicle, modifying in said second two-dimensional table said pairs of polar coordinates of angle θ and of distance d related to obstacle points, reducing the distance d of each of said obstacle points by taking into account transversal and longitudinal encumbrance sizes of the vehicle; and
the step b) is carried out on the pairs of polar coordinates of angle θ and of distance d of said second two-dimensional table.

7. The method according to claim 6, comprising, after the step a1) and before the step a2), the operations of:
defining concentric and adjacent circular sectors, with origin on said at least one sensor of the vehicle, having respective radiuses and central angles so as to envelope at least a front part of the vehicle; and
diminishing each distance d associated to each point of the first two-dimensional table by an amount equal to a radius of a circular sector to which the angle θ, associated to said point of the first two-dimensional table, belongs.

8. The method according to claim 2, wherein said performance score for each pair of angular speed ω and of tangential speed v stored in the table of admissible trajectories is established through the following operations:
c1) calculating a distance from an obstacle along the trajectory identified by said pair of values of angular speed ω and of tangential speed v;
c2) calculating an angular displacement in respect to an ideal trajectory directed towards an arrival point of the vehicle; and
c3) calculating said performance score with a function that increases when said distance from said obstacle and said tangential speed v increase and when said angular displacement decreases.

9. The method according to claim 8, wherein a minimum distance is defined in function of the tangential speed v, the method comprising the step of comparing said minimum distance with distances calculated at point c1), and discarding trajectories associated to distances from an obstacle smaller than said minimum distance.

10. A device for driving a vehicle equipped with at least an obstacle detection configured for carrying out operations of parallel computing of the method of driving according to claim 1, comprising:
an input interface functionally connectable with at least an obstacle detection sensor;
a processing unit for parallel computing, configured to:
receive first input signals representing values of tangential speed v that the vehicle may assume relatively to distances d of insurmountable obstacle points for each angle θ, in a running plane of the vehicle, for generating first intermediate signals representative of a first product mult1=2v sin θ,
receive second input signals representing values of angular speed ω that the vehicle may assume relatively to distances d of insurmountable obstacle points for each angle θ, in a running plane of the vehicle, for generating second intermediate signals representative of a second product mult2=d·ω,
carry out operations of the method for calculating a pair of values of angular speed ω and of tangential speed v to be imparted to the vehicle; and
an output interface coupled to the processing unit and functionally connectable with one or more motors of said vehicle, configured to transform said pair of values of angular speed ω and of tangential speed v in commands for driving the vehicle.

11. A driving system of a vehicle, comprising at least a 2D or 3D sensor configured to generate at each scanning period a set of pairs of planar coordinates or triples of cylindrical or spherical or Cartesian coordinates of detected obstacle points, functionally connected to a device according to claim 10.
